(19) United States
(12) Patent Application Publication
(10) Pub. No.: US 2017/0176308 A1
(43) Pub. Date: Jun. 22, 2017

(54) IMPACT PERFORMANCE TEST ANTI REBOUND DEVICE AND METHOD

(71) Applicant: SABIC GLOBAL TECHNOLOGIES B.V., Bergen op Zoom (NL)

(72) Inventor: Tom Koning, Heinkenszand (NL)

(73) Assignee: SABIC GLOBAL TECHNOLOGIES B.V., Bergen op Zoom (NL)

(21) Appl. No.: 15/129,751

(22) PCT Filed: Mar. 31, 2015
(86) PCT No.: PCT/IB2015/052378

§ 371 Date: Sep. 27, 2016

Related U.S. Application Data
(60) Provisional application No. 61/973,404, filed on Apr. 1, 2014.

(51) Int. Cl. G01N 3/303; G01M 7/08

(52) U.S. Cl. CPC G01N 3/303; G01M 7/08; G01M 99/00

(57) ABSTRACT

An apparatus and method for measuring the impact performance of a target material comprising a hollow structure comprising an outlet end located above a target. The hollow structure is dimensioned to allow free movement of a drop test object through the outlet end. A trigger is located proximate to the outlet end and a retaining member is located proximate to the outlet end and coupled to hollow structure. The retaining member is configured to retain the drop test object in the hollow structure upon activation of the trigger.

### BACKGROUND

Drop ball tests are used to test the impact performance of a target material such as a polymeric sheet. Depending upon the intended use of the sheet, certain standard criteria must be met. For example ECE Rule 43 dictates the standard for the impact strength of a plastic glazing for use in vehicles. ECE Rule 43 Annex 3 sets forth the testing conditions that are required to meet the standards.

A drop test object of specific dimensions and weight is dropped from a predetermined height and allowed to impact a test piece or target. It is required that the object can hit the test sample only one time. In most cases, were the object does not penetrate the test sample, the object will bounce back up in the air and drop down again to hit the sample for the second time. This will continue until all the energy is absorbed by the test sample. Impacts to the test sample after the first impact (rebound impacts) are not allowed. Accordingly, an apparatus and method for preventing a second or rebound impact is necessary.

Testing methods such as ECE Rule 43 include a process where a ball is dropped freely from a specified height. To prevent a rebound impact, a rope can be attached to the ball that can be pulled tight (via a pulley) when the ball is rebounded from the test sample. This option is not effective because the ball could rotate during the fall due to the weight and interaction of the rope. In addition, because there is a person operating the rope, human error is a possibility.

Another method for testing is to project the object to generate a velocity equivalent to that obtained by a free fall from a specified height. However, these methods (“drop towers”) can require complex braking systems and complicated components such as sensors and other electronics. As such, these methods are overly complex, expensive, and can require excessive maintenance.

Accordingly, there remains a need for a drop test apparatus and method that is efficient, inexpensive, and easy to use while meeting the relevant requirements, such as ECE Rule 43.

### BRIEF DESCRIPTION

An apparatus for measuring the impact performance of a target material comprising a hollow structure comprising an outlet end located above a target. The hollow structure is dimensioned to allow free movement of a drop test object through the outlet end. A trigger is located proximate to the outlet end and a retaining member is located proximate to the outlet end and coupled to hollow structure. The retaining member is configured to retain the drop test object in the hollow structure upon activation of the trigger.

A method for performing an impact strength test for a target material comprising directing a drop test object through a hollow structure at a predetermined distance from a target. The drop test object is allowed to rebound off the target and reenter an outlet end of the hollow structure. The drop test object is prevented from again exiting the outlet end of the hollow structure. A trigger is activated when the drop test object reenters the outlet end. The trigger activates a retaining member to prevent the drop test object from exiting outlet end.

A method for conducting an impact strength test for a target material comprising directing a drop test object through a hollow structure toward a target, impacting the target, and preventing a rebound impact of the drop test object with the target by collecting the drop test object within hollow structure.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is a cross sectional front view of an impact performance test apparatus.

FIG. 2 is a cross sectional front view of an impact performance test apparatus.

FIG. 3 is a cross sectional view of an exemplary hollow member for use in an impact performance test apparatus.

FIG. 4 is a front view of an impact performance test apparatus.

FIG. 5 is a cross sectional front view of an impact performance test apparatus.

### DETAILED DESCRIPTION

Disclosed herein are a drop test apparatus and methods for using the same. The drop test apparatus described herein allows the testing object to rebound off a target or testing surface and reenter the apparatus where it is retained by a retaining member to prevent a rebound impact on the testing surface. The retaining member is triggered by the rebound of the ball back into the apparatus. It is believed that the favorable results obtained herein, e.g., a repeatable, cost effective and efficient way of preventing rebound impacts during impact performance testing, can be achieved by dropping a drop test object through a hollow structure and using retaining member that is triggered to retain the drop test object within the hollow structure after the drop test object rebounds off the test piece and reenters the hollow structure.

Depending upon the intended use of a product, drop test standards are established by certain governing bodies. For example, a drop test can require that an impact object have a specific mass and/or dimension and can also require that the impact object is dropped from a predetermined height for impacting a target material or test piece. ECE Rule 43 governs the testing requirements for the mechanical strength of plastic glazing for use in vehicles, and is hereby incorporated by reference.

The test piece or target is held in place through a support. For example, the support can meet ECE Rule 43, which requires a supporting fixture, of steel frames, with machined borders 15 millimeters (mm) wide, fitting one over the other and faced with rubber gaskets about 3 mm thick and 15 mm wide and of hardness 50 International Rubber Hardness Degrees (IRHD). The lower frame rests on a steel box about 150 mm high. The test piece or target is held in place by the upper frame, the mass of which is about 3 kilograms (kg). The supporting frame is welded onto a sheet of steel of about 12 mm thick resting on the floor with an interposed sheet of rubber about 3 mm thick and of hardness 50 IRHD.

Depending upon the testing requirements, the drop test object can have any dimension, shape and/or mass. For example, the drop test object can be a hardened-steel ball (sphere) with a mass of 227±2 grams (g) and a diameter of approximately 38 mm, in accordance with ECE Rule 43.

The target or test piece can be of any dimension depending upon the requirements of the relevant testing procedure. For example, the target can be a flat square of sides 300 mm or can be cut from the flattest part of curved piece, in accordance with ECE Rule 43.

The drop test apparatus can include a hollow structure that is open at both ends. The structure can include any cross sectional shape provided a drop test ball can fit and freely move within the structure. For example, the structure can be a pipe (e.g., a circular cross section). The outlet end of the hollow structure can be greater in diameter than the other parts of the hollow structure to facilitate reentry of the drop test ball into the pipe after impact with the target.

At an outlet end of the hollow structure a trigger can be coupled to the structure. For example, the trigger can be removable or fixedly attached to the structure. The trigger can be activated when the drop test object reenters the outlet end of the hollow structure. For example, the vibration caused by the reentry of the drop test object can cause movement of the trigger (e.g., mechanical trigger). The trigger can include a light sensor, laser, ultrasonic trigger, Hall Effect sensor, magnet, vibration sensor, and combinations thereof.

The trigger activates a retaining member, which prevents the drop test object from exiting the hollow structure. The retaining member can include a magnet that is activated by the trigger to retain a magnetic test object within the hollow structure. The retaining member can include an actuator, such as a preloaded spring, that can move a stopper to at least partially cover the outlet end of the hollow structure and prevent the drop test ball from hitting the target a second time (e.g., a rebound impact). A stop surface can be utilized to position the stopper and prevent the stopper from moving to a position that is not sufficient to prevent the drop test ball from escaping the hollow structure. For example, a mechanical trigger can be placed between the stopper and the outlet end of the hollow structure. When the drop test object reenters the hollow structure, the vibrations caused by reentry can move the mechanical trigger thereby allowing the preloaded spring to move the stopper across a portion of the outlet end of the hollow structure. Thus, the drop test object can be retained within the hollow structure and prevented from impacting the target again (rebound impact).

The hollow structure, actuator, trigger, stopper, and stop surface can include various materials including, but not limited to, metallic material, ceramics, composites, polymeric material, and/or combinations thereof.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

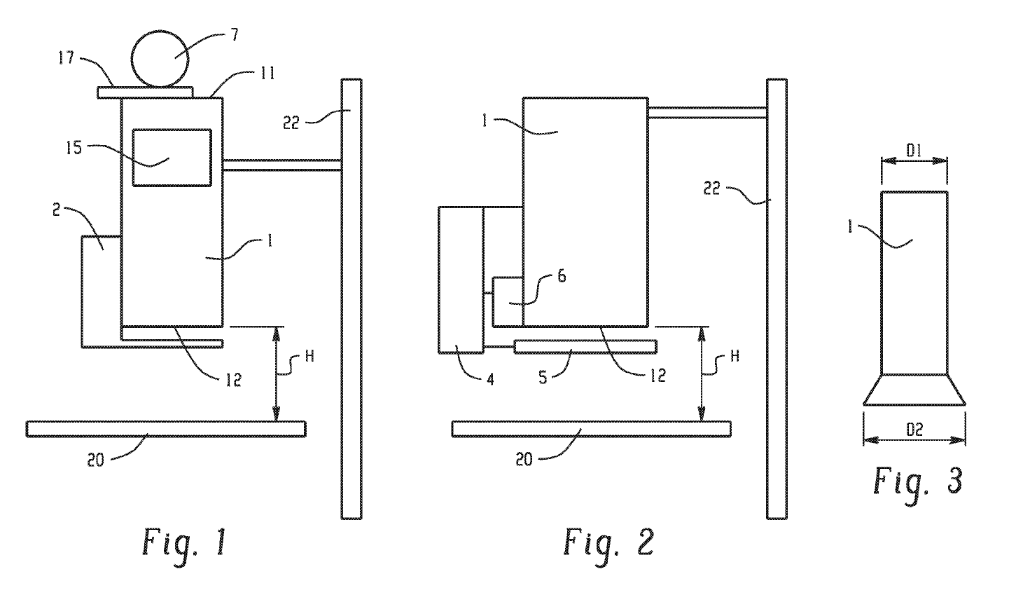

As shown in FIG. 1, a hollow structure 1 can be located a distance H above target 20. Depending upon the required testing conditions, H can vary by vertically adjusting the position of the outlet end 12 of hollow structure 1. The vertical adjustment can be accomplished by raising or lowering hollow structure 1 via support 22 that holds hollow structure 1 in place. In the alternative, the vertical adjustment can be accomplished by lowering target 20. Hollow structure 1 can be configured to guide the drop test object 7 in a direction within +/−3° of perpendicular to target 20. As shown in FIG. 1, drop test object 7 comprises a spherical or ball shape. Hollow structure 1 can have any cross sectional geometry and size to accommodate the free fall of drop test object 7. For example, the minimum diameter of hollow structure can be at least about 5% greater than the diameter of drop test object 7. The minimum diameter of hollow structure can be at least about 10% greater than the diameter of drop test ball 7.

Hollow structure 1 can include inlet end 11 and outlet end 12. Releasing member 17 can be coupled to the inlet end 11 and can be fixed or removable. Releasing member 17 is of sufficient strength to hold drop test object 7 until a test is to be performed. Releasing member 17 can be moveable from a position substantially blocking inlet end 11 to a position that allows drop test object 7 to pass through hollow structure 1. Releasing member can be a magnet, stopper, or any structure capable of holding drop test object 7 at a predetermined position. Hollow structure 1 can include one or more loading windows 15 that can be arranged at various points along an axis of hollow structure 1. In operation, drop test object 7 can be inserted through loading window 15 and allowed to pass through the remainder of hollow structure 1 toward target 20.

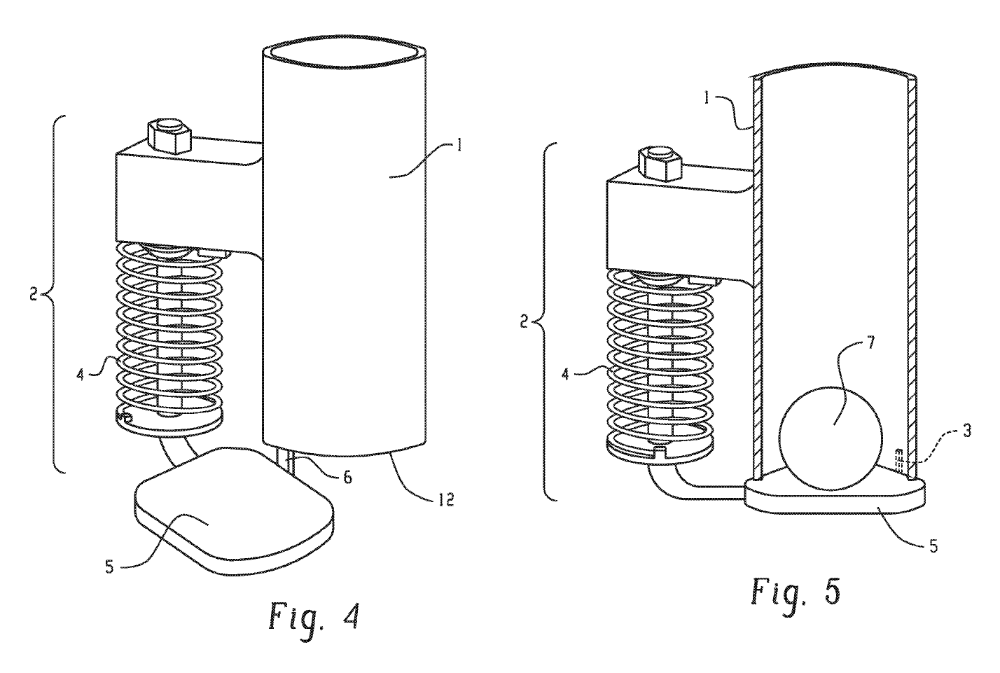

Retaining member 2 can be coupled to hollow structure 1. Retaining member 2 can include one or more magnets that are configured to retain a magnetic drop test object 7 within hollow structure 1 when activated by trigger 6. As shown in FIG. 2, retaining member 2 can include actuator 4 and stopper 5. As shown in FIGS. 4 and 5, actuator 4 can include a preloaded spring. Retaining member 2 can be mechanical (e.g., no electrical or magnetic components). Actuator 4 can include a pneumatic/hydraulic cylinder, electrical actuator, and similar devices.

As shown in FIG. 3, hollow structure 1 can include a greater diameter at outlet end 12 to facilitate the reentry of drop test ball 7 into the outlet end after impact with target 20. For example, the diameter D2 of outlet end 12 can be at least about 25% greater than the diameter D1 of inlet end 11. The diameter D2 of outlet end 12 can be at least about 50% greater than the diameter D2 of inlet end 11.

Depending upon the testing requirements, drop test object 7 can have any dimension, shape and/or mass. For example, the drop test ball can be a hardened-steel ball (sphere) with a mass of 227 g and a diameter of approximately 38 mm.

Target 20 can include any material and dimensions that are subject to the relevant testing standards. For example, target 20 can be a 300 mm by 300 mm flat piece of polycarbonate. Target 20 can be supported in any suitable manner. For example, target 20 can be supported as set forth in ECE Rule 43.

Trigger 6 can be coupled to hollow structure 1. After drop test object 7 impacts target 20 and reenters the outlet end of hollow structure 1, trigger 6 can activate actuator 4 to move stopper 5 into a closing position. For example, trigger 6 can include a surface that maintains actuator 4 in a preloaded position. When drop test object reenters outlet end 12, vibrations caused by the reentry can cause trigger 6 to move to a position where actuator 4 is able to move freely and position stopper 5 to at least partially obstruct outlet end 12. Stopper 5 can impact stop surface 3 to position stopper 5 in a desired location at least partially obstructing outlet end 12 and preventing drop test object from impacting target 20 as second time (e.g., rebound impact). Trigger 6 can also include can include a light sensor, laser, ultrasonic device, Hall Effect sensor, magnet, vibration sensor, mechanical device and combinations thereof. Thus, trigger 6 can send an electrical signal to retaining member 2 to initiate retention of the drop test object through the use of actuator 4 and stopper 5 or other available means, such as one or more magnets. Stop surface 3 can be coupled to an outer surface of hollow structure 1.

As shown in FIG. 5, stopper 5 can completely obstruct the outlet end of hollow structure 1. Stopper 5 can partially obstruct the outlet end of hollow structure 1. For example, stopper 5 can cover a minimal amount of outlet end 12 to prevent drop test ball 7 from exiting outlet end 12. Stopper 5 can cover at least 25% of the cross sectional area of outlet end 12. Stopper 5 can cover at least 50% of the cross sectional area of outlet end 12. Stopper 5 can include any geometric shape and can be identical to the shape of the cross section of outlet end 12. In the alternative, stopper 5 can include a shape different from the cross section of outlet end 12.

In operation, drop test object 7 is dropped through hollow structure 1 and impacts target 20. Drop test object 7 rebounds off target 20 and reenters hollow structure 1 through outlet end 20. Trigger 6 is activated by the reentry of drop test object 7 and activates retaining member 2. Trigger 6 can be mechanical, magnetic, or electrical. For example, trigger 6 can include a light sensor, laser, ultrasonic device, Hall Effect sensor, magnet, vibration sensor, mechanical device and combinations thereof. As shown in FIGS. 5 and 6, retaining member 2 can include actuator 4 and stopper 5. Actuator 4 can be a preloaded spring held in place by trigger 6 and allowed to move when drop test object 7 causes trigger 6 to move to a position where it is no longer restraining actuator 4. For example, trigger 6 can be made to release actuator 4 as a result of vibrations from drop test object 7 impacting an inner surface of hollow structure 1 when drop test object 7 reenters hollow structure 1 after rebounding off target 20. Trigger 6 can also send a signal to actuator 4 to prompt movement of stopper 5. Actuator 4 can be coupled to stopper 5 which can be moved by actuator 4 until it impacts stop surface 3 and obstructs at least a portion of outlet end 12, preventing drop test ball 7 from impacting target 20 a second time. When drop test ball 7 has reached his highest point inside the hollow structure 1, it will drop again until it hits stopper 5.

### EXAMPLES

### Example 1

It is to be understood that the materials and methods are not limited to those disclosed herein and used in the examples.

A drop test apparatus as described above in connection with FIGS. 4 and 5 comprising a metal tube 300 cm in length was set with a bottom surface of the tube 10 cm from a target. The target comprised a polycarbonate sheet with a thickness of 4 mm and was supported in accordance with ECE Regulation 43. The testing conditions met the standards set forth in ECE Regulation 43. A total of 40 drops of a 227 g steel ball with a diameter of 38 mm were successfully completed without a rebound impact or failure of any of the components of the drop test apparatus.

Set forth below are some embodiments of connectors and methods of making connectors as disclosed herein.

Embodiment 1: An apparatus for measuring the impact performance of a target material comprising: a hollow structure comprising an outlet end located above a target; wherein the hollow structure is dimensioned to allow free movement of a drop test object through the outlet end; a trigger located proximate to the outlet end; a retaining member located proximate to the outlet end and coupled to hollow structure; and wherein the retaining member is configured to retain the drop test object in the hollow structure upon activation of the trigger.

Embodiment 2: An apparatus for measuring the impact performance of a target material comprising: a hollow structure comprising an outlet end located above a target; wherein the hollow structure is dimensioned to allow free movement of a drop test object through the outlet end; a trigger located proximate to the outlet end; and a retaining member located proximate to the outlet end and coupled to hollow structure; and wherein upon activation of the trigger, the retaining member retains the drop test object in the hollow structure.

Embodiment 3: The apparatus of any of the preceding Embodiments, wherein the retaining member comprises an actuator coupled to a stopper.

Embodiment 4: The apparatus of Embodiment 3, further comprising a stop surface configured to position the stopper across a portion of the outlet end.

Embodiment 5: The apparatus of any of Embodiments 3-4, wherein the stopper is configured to close at least a portion of the outlet end.

Embodiment 6: The apparatus of any of Embodiments 3-5, wherein the actuator comprises a spring mechanism, a pneumatic cylinder, hydraulic cylinder, or a combination comprising at least one of the foregoing.

Embodiment 7: The apparatus of any of the preceding Embodiments, wherein the trigger comprises a light sensor, laser, ultrasonic device, Hall effect sensor, magnet, vibration sensor, mechanical device, or a combination comprising at least one of the foregoing.

Embodiment 8: The apparatus of any of the preceding Embodiments, wherein the retaining member is a magnet and the drop test ball is magnetic.

Embodiment 9: The apparatus of any of the preceding Embodiments, further comprising a releasing member configured to retain drop test object at a predetermined height.

Embodiment 10: The apparatus of any of the preceding Embodiments, wherein the hollow structure further comprises a loading window at predetermined height along the hollow structure.

Embodiment 11: The apparatus of any of the preceding Embodiments, further comprising an adjustable support coupled to the hollow structure.

Embodiment 12: The apparatus of any of the preceding Embodiments, wherein the cross-sectional area of the hollow structure is greatest at the outlet end.

Embodiment 13: The apparatus of any of the preceding Embodiments, wherein the drop test object meets the standard set forth in ECE Regulation 43.

Embodiment 14: The apparatus of any of the preceding Embodiments, wherein the hollow structure is configured to guide the drop test object in a direction within +/−3° of perpendicular to the target.

Embodiment 15: A method for performing an impact strength test for a target material using the apparatus of any of the preceding Embodiments, the method comprising: directing a drop test object through a hollow structure at a predetermined distance from a target; allowing the drop test object to rebound off the target and reenter an outlet end of the hollow structure; preventing the drop test object from again exiting the outlet end of the hollow structure; wherein a trigger is activated when the drop test object reenters the outlet end; and wherein the trigger activates a retaining member to prevent the drop test object from exiting outlet end.

Embodiment 16: The method of Embodiment 15, wherein the retaining member comprises an actuator coupled to a stopper.

Embodiment 17: The method of Embodiment 16, wherein the actuator comprises a spring mechanism, a pneumatic cylinder, hydraulic cylinder, and combinations thereof.

Embodiment 18: The method of any of Embodiments 15-17, wherein the trigger comprises a light sensor, laser, ultrasonic device, Hall effect sensor, magnet, vibration sensor, mechanical device, and combinations thereof.

Embodiment 19: The method of any of Embodiments 16-18, wherein the stopper closes at least a portion of outlet end when activated by trigger.

Embodiment 20: The method of any of Embodiments 15-19, wherein the retaining member is a magnet.

Embodiment 21: The method of any of Embodiments 15-20, wherein directing the drop test object comprises moving a releasing member to allow the drop test object to move.

Embodiment 22: The method of any of Embodiments 15-21, wherein directing the drop test object comprises loading the drop test object into a loading window.

Embodiment 23: The method of any of Embodiments 15-22, wherein the drop test object meets the standard set forth in ECE Regulation 43.

Embodiment 24: The method of any of Embodiments 15-23, wherein the hollow structure is configured to guide the drop test object in a direction within +/−3° of perpendicular to the target.

Embodiment 25: A method for conducting an impact strength test for a target material comprising: directing a drop test object through a hollow structure toward a target; and impacting the target preventing a rebound impact of the drop test object with the target by collecting the drop test object within hollow structure.

Embodiment 26: The method of Embodiment 25, wherein the collecting the drop test object comprises a trigger and a retaining member that prevents the drop test object from exiting the hollow structure.

Embodiment 27: The method of Embodiment 26, wherein the retaining member comprises an actuator coupled to a stopper.

Embodiment 28: The method of Embodiment 27, wherein the actuator comprises a spring mechanism, a pneumatic cylinder, hydraulic cylinder, and combinations thereof.

Embodiment 29: The method of any of Embodiments 25-27, wherein the trigger comprises a light sensor, laser, ultrasonic device, Hall effect sensor, magnet, vibration sensor, mechanical device, and combinations thereof.

Embodiment 30: The method of Embodiment 26, wherein the stopper closes at least a portion of outlet end when activated by trigger.

Embodiment 31: The method of any of Embodiments 25-30, wherein the retaining member is a magnet.

In general, the invention may alternately include, comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. As used herein, ECE Rule 43 refers to the particular rule in effect as of Apr. 1, 2014.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/We claim:

1. An apparatus for measuring the impact performance of a target material comprising:
a hollow structure comprising an outlet end located above a target;
wherein the hollow structure is dimensioned to allow free movement of a drop test object through the outlet end;
a trigger located proximate to the outlet end;
a retaining member located proximate to the outlet end and coupled to the hollow structure; and
wherein the retaining member is configured to retain the drop test object in the hollow structure upon activation of the trigger.

2. The apparatus of claim 1, wherein the retaining member comprises an actuator coupled to a stopper.

3. The apparatus of claim 2, further comprising a stop surface configured to position the stopper across a portion of the outlet end.

4. The apparatus of claim 2, wherein the stopper is configured to close at least a portion of the outlet end.

5. The apparatus of claim 2, wherein the actuator comprises a spring mechanism, a pneumatic cylinder, hydraulic cylinder, or a combination comprising at least one of the foregoing.

6. The apparatus of claim 1, wherein the trigger comprises a light sensor, laser, ultrasonic device, Hall effect sensor, magnet, vibration sensor, mechanical device, or a combination comprising at least one of the foregoing.

7. The apparatus of claim 1, wherein the retaining member is a magnet and the drop test ball is magnetic.

8. The apparatus of claim 1, further comprising a releasing member configured to retain drop test object at a predetermined height.

9. The apparatus of claim 1, wherein the hollow structure further comprises a loading window at predetermined height along the hollow structure.

10. The apparatus of claim 1, further comprising an adjustable support coupled to the hollow structure.

11. The apparatus of claim 1, wherein the cross-sectional area of the hollow structure is greatest at the outlet end.

12. The apparatus of claim 1, wherein the drop test object meets the standard set forth in ECE Regulation 43.

13. The apparatus of claim 1, wherein the hollow structure is configured to guide the drop test object in a direction within +/−3° of perpendicular to the target.

14. A method for performing an impact strength test for a target material using the apparatus of claim 1, comprising:
directing a drop test object through a hollow structure at a predetermined distance from a target;
allowing the drop test object to rebound off the target and reenter an outlet end of the hollow structure; and
preventing the drop test object from again exiting the outlet end of the hollow structure;
wherein a trigger is activated when the drop test object reenters the outlet end; and
wherein the trigger activates a retaining member to prevent the drop test object from exiting outlet end.

15. The method of claim 14, closing at least a portion of the outlet end with the stopper when activated by trigger.

16. The method of claim 14, wherein directing the drop test object comprises moving a releasing member to allow the drop test object to move.

17. The method of claim 14, wherein directing the drop test object comprises loading the drop test object into a loading window.

18. A method for conducting an impact strength test for a target material comprising:
directing a drop test object through a hollow structure toward a target;
impacting the target; and
preventing a rebound impact of the drop test object with the target by collecting the drop test object within hollow structure.
